(19) United States
(12) Patent Application Publication
(10) Pub. No.: US 2024/0221059 A1
(43) Pub. Date: Jul. 4, 2024

(54) SYSTEMS AND METHODS FOR MANAGING GIFTING STRATEGIES VIA IMPROVED GRAPHICAL INTERFACES

(71) Applicant: Villanova Tech, LLC, Berwyn, PA (US)

(72) Inventors: Michael Bolesta, West Chester, PA (US); James Chakey, Havertown, PA (US); Thomas Kerr, Downingtown, PA (US); Bryan Mey, Newark, DE (US); Kyung Min, Blue Bell, PA (US); Neil O'Connell, West Chester, PA (US); Matthew Quinn, Lafayette Hill, PA (US); John Treese, Schwenksville, PA (US); Kristine Treese, Schwenksville, PA (US); Edmond Walters, Naples, FL (US); Theodore Walters, Haddonfield, NJ (US)

(21) Appl. No.: 18/394,061

(22) Filed: Dec. 22, 2023

Related U.S. Application Data
(60) Provisional application No. 63/436,136, filed on Dec. 30, 2022.

(51) Int. Cl. G06Q 30/0601; G06Q 20/40

(52) U.S. Cl. CPC G06Q 30/0641; G06Q 20/4014

(57) ABSTRACT

Methods, financial management systems, and non-transitory computer readable media for managing gifting strategies are disclosed. In some examples, a gifting strategy interface is provided to a user device following authentication of login credentials. The gifting strategy interface is generated based on demographic and cumulative gift data for an individual and comprises a graphical illustration of a monetary value of gifts made by the individual to family members. Gift data is communicated via communication networks and a provided API to a financial institution or investment management server to execute a current gift and facilitate a transfer of electronic funds in response to a gift request from the user device via the gifting strategy interface. The gift request comprises a current gift amount and an identity of one of the family members. The graphical illustration is adjusted to reflect, and the cumulative gift data is updated based on, the executed gift.

This application claims priority to U.S. Provisional Patent Application No. 63/436,136, filed Dec. 30, 2022, which is incorporated by reference herein in its entirety.

### TECHNICAL FIELD

This disclosure generally relates to financial planning technology and associated graphical interfaces and, more specifically, to systems and methods for managing gifting strategies via improved graphical interfaces.

### BACKGROUND

Managing gifting and tax strategies and related financial planning is challenging, particularly for high-net-worth individuals with significant assets, large families, and/or complicated distributions. Current financial planning software tools lack effective graphical displays for informing gifting strategies and associated lifetime and cash flow impact, integrations that facilitate more fulsome data relating to historical gifts, income, and/or family members, for example, and efficient implementation of gifting strategies.

Thus, current financial planning technology is ineffective and inefficient for advanced financial advisors and wealth managers, let alone high-net-worth individuals, with respect to managing and implementing gifting strategies.

### SUMMARY

In one embodiment, a method implemented by a financial management system is disclosed that includes obtaining and storing demographic data and cumulative gift data for an individual. The demographic data comprises identities of family members of, and a relationship of the family members to, the individual and the gift data comprises an amount and a first one of the identities for gifts made by the individual. A current gifting strategy interface is provided to a user device for display following authentication of login credentials corresponding to the individual. The current gifting strategy interface is generated based on at least the demographic data and the cumulative gift data and comprises a first graphical illustration of a respective monetary value of a subset of the gifts made by the individual to a subset of the family members. A current gift is executed in response to a current gift request received from the user device via the current gifting strategy interface. The current gift request comprises current gift data obtained via current gifting input fields of the current gifting strategy interface and comprising at least a current gift amount and a second one of the identities. The second one of the identities is associated with one of the subset of the family members. The first graphical illustration is automatically adjusted to reflect, and the cumulative gift data is updated based on, the executed current gift.

In some examples, financial data for the individual is obtained and stored. The financial data comprises indications of assets of the individual and the current gift data comprises one of the indications corresponding to a source of the current gift. A subset of the family members can comprise a plurality of individuals within the family members or one or more subfamilies of a family that comprises the family members.

In other examples, the current gift data is communicated via one or more communication networks and a provided application programming interface (API) to a financial institution server or an investment management server to execute the current gift and facilitate a current or future transfer of electronic funds. The cumulative gift data can comprise historical gift data and future gift data. In these examples, a unified credit interface can be generated based on the financial data and the cumulative gift data and comprising a second graphical illustration of historical unified credit utilization of the individual is provided to the user device for display.

In yet other examples, a lifetime interface comprising a second graphical illustration of a wealth of the individual over a period time is provided to the user device for display. The wealth is determined based on the financial data and the cumulative gift data and the second graphical illustration reflects an impact of a gifting strategy reflected in the cumulative gift data.

Additionally, a family tree graphically illustrating the relationship of the family members to the individual determined from the demographic data can be generated and a family tree interface can be provided to the user device for display that comprises the generated family tree and an indication of a cumulative monetary value of one or more of the gifts to each of the family members determined from the cumulative gift data. The family tree interface is further configured to generate an overlay in response to a selection from the user device of one of the family members. The overlay comprises selectable trust needs associated with the one of the family members and a breakdown of the cumulative monetary value of the one or more of the gifts to the one of the family members.

In another embodiment, a financial management system is disclosed that comprises memory comprising instructions stored thereon and one or more processors coupled to the memory and configured to execute the stored instructions. In this embodiment, a current gifting strategy interface is provided to a user device for display following authentication of login credentials corresponding to an individual. The current gifting strategy interface is generated based on at least demographic data and cumulative gift data for the individual and comprises a first graphical illustration of a monetary value of each of a subset of gifts made by the individual to a subset of family members of the individual. A current gift is executed in response to a current gift request received from the user device via the current gifting strategy interface. The current gift request comprises current gift data obtained via current gifting input fields of the current gifting strategy interface and comprising at least a current gift amount and a first one of a plurality of identities of the family members. The first one of the identities is associated with one of the subset of the family members. The first graphical illustration is automatically adjusted to reflect, and the cumulative gift data is updated based on, the executed current gift.

In some examples, the one or more processors are further configured to execute the stored instructions to provide to the user device for display a future gifting interface comprising a second graphical illustration and a plurality of future gifting input fields comprising one or more of a future gift amount, a retirement age, an inflation rate, a gift frequency, or a gift duration. The future gifting interface is configured to automatically adjust the second graphical illustration in response to a received modification of a value associated with one or more of the future gifting input fields. Additionally, the second graphical illustration reflects an estimate future gift value of the future gift.

In other examples, the one or more processors are further configured to execute the stored instructions to execute a future gift in response to a future gift request received from the user device via the future gifting strategy interface. The future gift request comprises a third one of the identities and future gift data obtained via the future gifting input fields. The cumulative gift data is updated based on the executed future gift.

In yet other examples, the one or more processors are further configured to execute the stored instructions to obtain and store the demographic data and the cumulative gift data for the individual. The demographic data comprises the identities and a relationship of the family members to the individual and the gift data comprises an amount and a second one of the identities for gifts made by the individual.

In yet another embodiment, a non-transitory computer readable medium having stored thereon instructions comprising code executable one or more processors is disclosed. A current gifting strategy interface is provided to a user device for display following authentication of login credentials corresponding to an individual. The current gifting strategy interface is generated based on at least demographic data and cumulative gift data for the individual and comprises a first graphical illustration of a monetary value of each of a subset of gifts made by the individual to a subset of family members of the individual. Current gift data is communicated via communication networks and a provided API to a financial institution server or an investment management server to execute a current gift and facilitate a transfer of electronic funds in response to a current gift request received from the user device via the current gifting strategy interface. The current gift request comprises current gift data obtained via current gifting input fields of the current gifting strategy interface and comprising at least a current gift amount and a first one of a plurality of identities of the family members and the first one of the identities is associated with one of the subset of the family members. The first graphical illustration is automatically adjusted to reflect, and the cumulative gift data is updated based on, the executed current gift.

In some examples, the executable code, when executed by the one or more processors, further causes the one or more processors to obtain and store financial data for the individual. The financial data comprises indications of assets of the individual and the current gift data comprises one of the indications corresponding to a source of the current gift. In other examples, the executable code, when executed by the one or more processors, further causes the one or more processor to generate a family tree graphically illustrating a relationship of the family members to the individual determined from the demographic data. A family tree interface comprising the generated family tree and an indication of a cumulative monetary value of one or more of the gifts to each of the family members determined from the cumulative gift data is then provided to the user device for display.

In yet other examples, the cumulative gift data comprises historical gift data and future gift data and the executable code, when executed by the one or more processors, further causes the one or more processor to provide to the user device for display a lifetime interface comprising a second graphical illustration of a wealth of the individual over a period time. The wealth is determined based on the financial data and the cumulative gift data and the second graphical illustration reflects an impact of a gifting strategy reflected in the cumulative gift data.

Additionally, the executable code, when executed by the one or more processors, can further cause the one or more processor to provide to the user device for display a future gifting interface comprising a second graphical illustration and a plurality of future gifting input fields. A future gift is executed in response to a future gift request received from the user device via the future gifting strategy interface. The future gift request comprises a third one of the identities and future gift data obtained via the future gifting input fields. The cumulative gift data is updated based on the executed future gift.

### BRIEF DESCRIPTION OF THE DRAWINGS

FIG. 1 is a block diagram of an exemplary network environment with a financial management system;

FIG. 2 is a block diagram of an exemplary financial management system;

FIG. 3 is a flowchart of an exemplary method for managing gifting strategies;

FIG. 4 is an exemplary profile dashboard interface;

FIG. 5 is a flowchart of an exemplary method for managing gifting requests;

FIG. 6 is an exemplary individual gifting strategy interface;

FIG. 7 is an exemplary family gifting strategy interface;

FIG. 8 is an exemplary future gifting interface;

FIG. 9 is a flowchart of an exemplary method for managing fairness requests;

FIG. 10 is an exemplary family tree interface;

FIG. 11 illustrates the family tree interface of FIG. 10 with an individual overlay;

FIG. 12 is an exemplary individual fairness interface;

FIG. 13 is an exemplary family fairness interface;

FIG. 14 is an exemplary unified credit interface;

FIG. 15 is an exemplary lifestyle interface; and

FIG. 16 is an exemplary lifetime cash flow interface.

### DETAILED DESCRIPTION

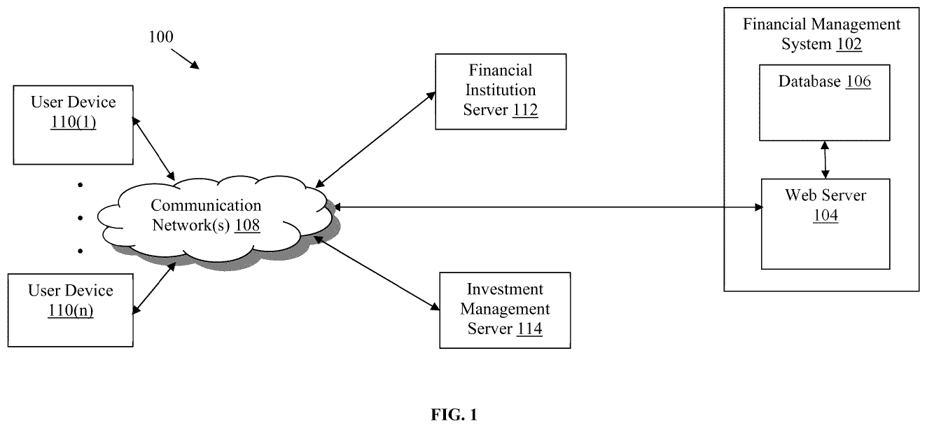

Referring to FIG. 1, an exemplary network environment 100 is illustrated that includes a financial management system 102, with a web server 104 coupled to a backend database 106, which is coupled via communication network(s) 108 to user devices 110(1)-110(n), at least one financial institution server 112, and/or at least one investment management server 114. The network environment 100 may include other network devices such as one or more routers or switches, for example, which are known in the art and thus will not be described herein. This technology has a number of advantages including methods, non-transitory computer readable media, and systems that provide improved graphical interfaces that integrate with external data sources to provide aggregated data to inform, and facilitate implementation of, gifting strategies, particularly for high-net-worth individuals.

In this example, the user devices 110(1)-110(n), financial institution server 112, investment management server 114, web server 104, and database 106 are disclosed in FIG. 1 as dedicated hardware devices. However, one or more of the user devices 110(1)-110(n), financial institution server 112, investment management server 114, web server 104, or database 106 can also be implemented in software within one or more other devices in the network environment 100. As one example, the investment management server 114, as well as any of its components or applications, can be implemented as software executing on the web server 104, and many other permutations and types of implementations and network topologies can also be used in other examples.

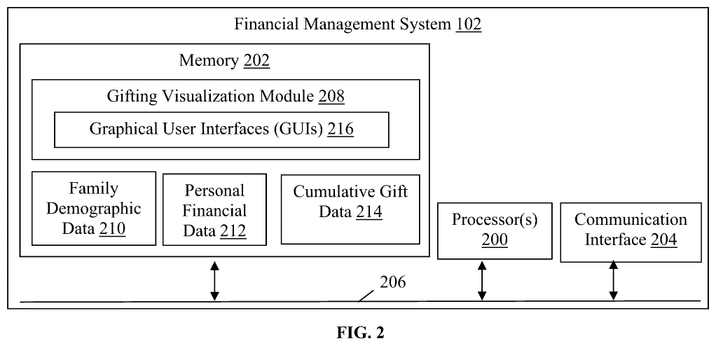

Referring to FIGS. 1-2, the financial management system 102 may perform any number of functions, including providing graphical user interfaces (GUIs) to the user devices 110(1)-110(n) and/or presenting aggregated and processed data obtained from the user devices 110(1)-110(n), financial institution server 112, and/or investment management server 114. The financial management system 102 (e.g., the web server 104 of the financial management system 102) in this example includes processor(s) 200, memory 202, and a communication interface 204, which are coupled together by a bus 206, although the financial management system 102 can include other types or numbers of elements in other configurations.

The processor(s) 200 of the financial management system 102 may execute programmed instructions stored in the memory 202 of the financial management system 102 for any number of the functions described and illustrated herein. The processor(s) 200 may include one or more general purpose processors with one or more processing cores, one or more central processing units (CPUs), and/or one or more graphics processing units (GPUs), for example, although other types of processor(s) can also be used.

The memory 202 stores these programmed instructions for one or more aspects of the present technology as described and illustrated herein, although some or all of the programmed instructions could be stored elsewhere. A variety of different types of storage devices, such as random-access memory (RAM), read-only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store applications that can include computer executable instructions that, when executed by the processor(s) 200, cause the financial management system 102 to perform actions, such as to transmit, receive, or otherwise process network messages and requests, for example, and to perform other actions described and illustrated below. The application(s) can be implemented as components of other applications, operating system extensions, and/or plugins, for example.

Further, the application(s) may be operative in a cloud-based computing environment with access provided via a software-as-a-service (SaaS) model. The application(s) can be executed within or as virtual machine(s) or virtual server(s) that may be managed in a cloud-based computing environment. Also, the application(s), and even the financial management system 102 itself, may be located in virtual server(s) running in a cloud-based computing environment rather than being tied to specific physical network computing devices. Also, the application(s) may be running in virtual machines (VMs) executing on the financial management system 102 and managed or supervised by a hypervisor.

In this example, the memory 202 includes a gifting visualization module 208, family demographic data 210, personal financial data 212, and cumulative gift data 214. In some examples, the family demographic data 210, personal financial data 212, and cumulative gift data 214 can be maintained in the database 106 of the financial management system 102, which can be a relational database (e.g., a Structured Query Language (SQL) database), although other types of databases can also be used in other examples.

The gifting visualization module 208 is configured to interface with the financial institution server 112 and/or investment management server 114 (e.g., using provided application programming interfaces (APIs)) to ingest the personal financial data 212 and/or a portion of the cumulative gift data 214 relating to historical gifts. The gifting visualization module 208 is further configured to interface with the user devices 110(1)-110(n), for example, to obtain the family demographic data 210 and another portion of the cumulative gift data 214 relating to current and future gifts. The ingested and obtained data can then be stored in the memory 202 (e.g., in the database 106).

The gifting visualization module 208 also aggregates and processes the ingested and obtained data to generate improved GUIs 216 including dashboards with a particular arrangement of features and graphical components that results in an improved user experience via simultaneous display of cumulative gift data 214 for families and particular family members along with functionality capable of implementing monetary gifts (e.g., via integration with the financial institution server 112 and/or investment management server 114). Accordingly, the GUIs 216 of this technology require a specific, structured dashboard interface paired with a prescribed functionality directly related to a GUI's 216 structure that is addressed to and resolves specific problems in the prior state of the art via interactive family tree, unified credit, fairness, lifestyle, gifting strategy, and lifetime cash flow interfaces with granular detail, as described and illustrated in more detail below.

The communication interface 204 of the financial management system 102 operatively couples and communicates between the financial management system 102, user devices 110(1)-110(n), financial institution server 112, and/or investment management server 114, which are coupled together at least in part by the communication network(s) 108 in this particular example, although other types or numbers of networks or systems with other types or numbers of connections or configurations to other devices or elements can also be used. The communication network(s) 108 can include wide area network(s) (WAN(s)) and/or local area network(s) (LAN(s)), for example, and can use TCP/IP over Ethernet and industry-standard protocols, although other types or numbers of protocols or communication networks can be used. The communication network(s) 108 can employ any suitable interface mechanisms and network communication technologies including, for example, Ethernet-based Packet Data Networks (PDNs).

The financial management system 102 in some examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory 202, communication interface 204, or other hardware or software components of one or more other devices included in the financial management system 102. Additionally, one or more of the devices that together comprise the financial management system 102 in other examples can be standalone devices or integrated with one or more other devices or apparatuses.

Each of the financial institution server 112 and investment management server 114 can include a processor, memory, and a communication interface, which are coupled together by a bus or other communication link (not illustrated), although other numbers or types of components could also be used. The financial institution server 112 can be associated with a bank, for example, and can store and provide personal financial data including information regarding income and assets, for example.

The investment management server 114 can be associated with an investment management firm, for example, and can store and provide information regarding investment income, investment assets, trusts, and/or historical gifts, for example. The financial institution server 112 and/or investment management server 114 can provide an API to facilitate implementation of gifts via a dashboard provided by the financial management system 102, as explained in more detail below.

Each of the user devices 110(1)-110(n) of the network environment 100 in this example includes any type of computing device that can exchange network data, such as mobile, desktop, laptop, or tablet computing devices, virtual machines (including cloud-based computers), or the like. Each of the user devices 110(1)-110(n) in this example includes a processor, memory, and a communication interface, which are coupled together by a bus or other communication link (not illustrated), although other numbers or types of components could also be used.

Each of the user devices 110(1)-110(n) may run services and/or interface applications, such as standard web browsers or the standalone applications, which may provide an interface to communicate with the financial management system 102 via the communication network(s) 108. Each of the user devices 110(1)-110(n) may further include a display device, such as a display screen or touchscreen, or an input device, such as a keyboard or mouse, for example (not shown). One or more of the user devices 110(1)-110(n) may be associated with an individual user (e.g., a high-net-worth individual) and/or a financial advisor or wealth planner for such an individual user, for example.

Although the exemplary network environment 100 with the user devices 110(1)-110(n), financial management system 102, financial institution server 112, investment management server 114, and communication network(s) 108 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the user devices 110(1)-110(n), financial management system 102, financial institution server 112, or investment management server 114, for example, may be configured to operate as virtual instances on the same physical machine. In other words, one or more of the user devices 110(1)-110(n), financial management system 102, financial institution server 112, or investment management server 114 may operate on the same physical device rather than as separate devices communicating through the communication network(s) 108. Additionally, there may be more or fewer user devices, financial management systems, financial institution servers, or investment management servers than illustrated in FIG. 1.

The examples of this technology may also be embodied as one or more non-transitory computer readable media having instructions stored thereon, such as in the memory 202 of the financial management system 102, for one or more aspects of the present technology, as described and illustrated by way of the examples herein. The instructions in some examples include executable code that, when executed by one or more processors, such as the processor(s) 200 of the financial management system 102, cause the processors to carry out steps necessary to implement the methods of the examples of this technology that will now be described and illustrated herein.

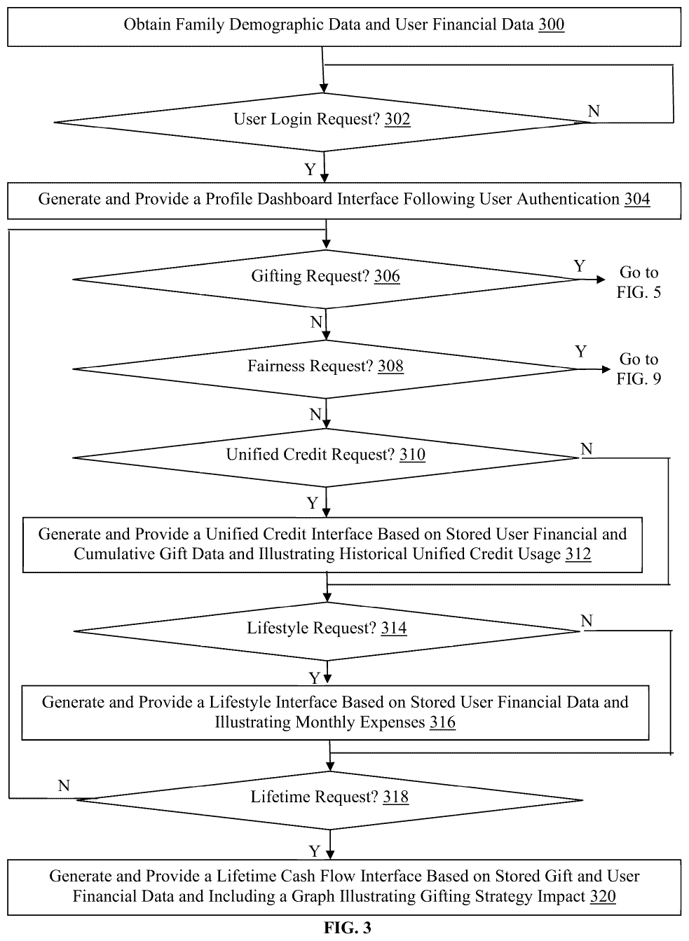

Referring now to FIG. 3, a flowchart of an exemplary method for managing gifting strategies is illustrated. In step 300 in this example, the financial management system 102 obtains family demographic data 210 and personal financial data 212 optionally from one or more of the financial institution server 112 or the investment management server 114, for example, although other sources of the data can be used. The family demographic data 210 can include at least demographic information (e.g., age, gender, income level) and an identity and relationship of family members for a plurality of families of users of the financial management system 102. The personal financial data 212 can include asset information (e.g., type or value) and income data (e.g., source or amount), among other financial information for users of the financial management system 102. Optionally, data regarding historical gifts (i.e., cumulative gift data 214) for users of the financial management system 102 (e.g., amount, recipient, or source) can also be obtained in step 300.

In step 302, the financial management system 102 determines whether a login request is received from one of the user devices 110(1)-110(n). If the financial management system 102 determines a login request has not been received, then the No branch is taken back to step 302 and the financial management system 102 effectively waits for a login request to be received. However, if the financial management system 102 determines that a login request has been received, then the Yes branch is taken to step 304.

In step 304, the financial management system 102 generates and provides to the user device 110 a profile dashboard interface following authentication of the user associated with the received login request, such as based on a username and password, for example. The profile dashboard interface can be generated based on stored portions of the family demographic data 210 and the personal financial data 212 that correlates with a unique identifier (e.g., username) included with the received user login request.

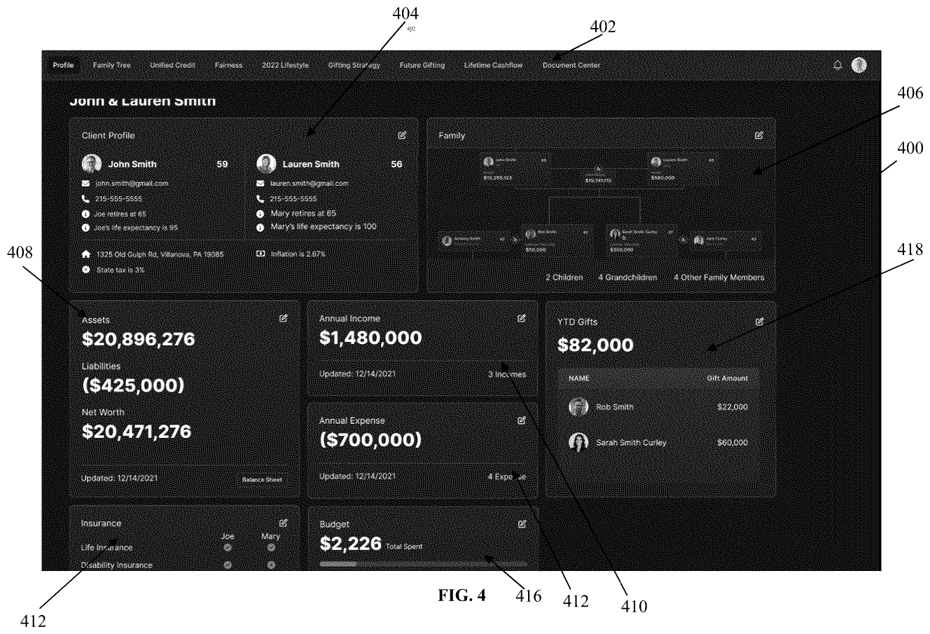

Referring to FIG. 4, an exemplary profile dashboard interface 400 is illustrated. In some examples, the profile dashboard interface 400 is the initial webpage displayed to a user and provides high level demographic and financial information. The demographic and/or financial information data could have been obtained in step 300 via an integration from one or more wealth management products hosted by a financial advisor (e.g., MoneyGuide™ available from Envestnet, Inc. of Berwyn, PA), for example. The profile dashboard interface 400 interface includes a menu bar 402 with various selectable links to additional dashboards and interfaces, which will be described in more detail below.

In this example, the profile dashboard interface 400 includes various modules including a client profile module 404 with contact information for the user, a family module 406 with at least a portion of a family tree generated from family demographic data 210 associated with the user, assets, annual income, annual expenses, insurance, and budget modules 408-416 with data extracted from the personal financial data 212 associated with the user, and a year-to-date (YTD) gift module 418 generated from cumulative gift data 214 associated with the user. Other modules can be included in the profile dashboard interface 400 in other examples. Optionally, one or more of the modules can facilitate editing of the associated displayed information (e.g., by a financial visor and/or user) to improve accuracy. Thus, the profile dashboard interface 400 allows for high level fact-finding and confirmation of provided data.

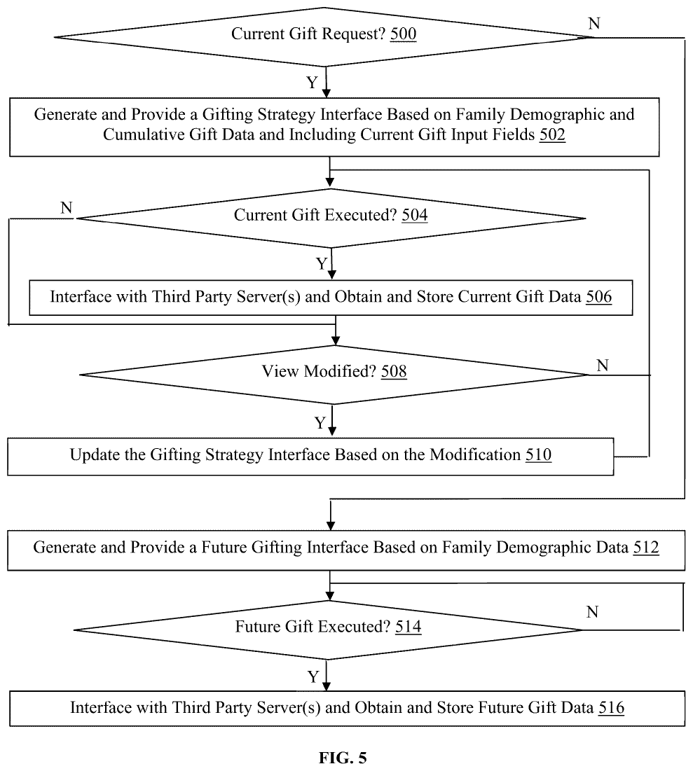

Referring back to FIG. 3, in step 306, the financial management system 102 determines whether a gifting request has been received. A gifting request can be received via a user interaction with the menu bar 402 of the profile dashboard interface 400, for example. In this example, a gifting request can be a current gift request or a future gift request initiated via interaction with a gifting strategy link or a future gifting link of the menu bar 402, respectively, although other types of gifting requests could also be received in other examples. If the financial management system 102 determines that a gifting request has been received, then the Yes branch is taken to step 500 of FIG. 5.

In FIG. 5, a flowchart of an exemplary method for managing gifting requests is illustrated. In step 500, the financial management system 102 determines whether the gifting request is a current gift request (e.g., based on the link selected from the menu bar 402 of the profile dashboard interface 400). If the financial management system 102 determines that the gifting request is a current gift request, then the Yes branch is taken to step 502.

In step 502, the financial management system 102 generates and provides to the user device 110 a gifting strategy interface based on family demographic data 210 and cumulative gift data 214 correlated with the user. The gifting strategy interface includes current gift input fields that facilitate implementation of a current gift (e.g., to a family member).

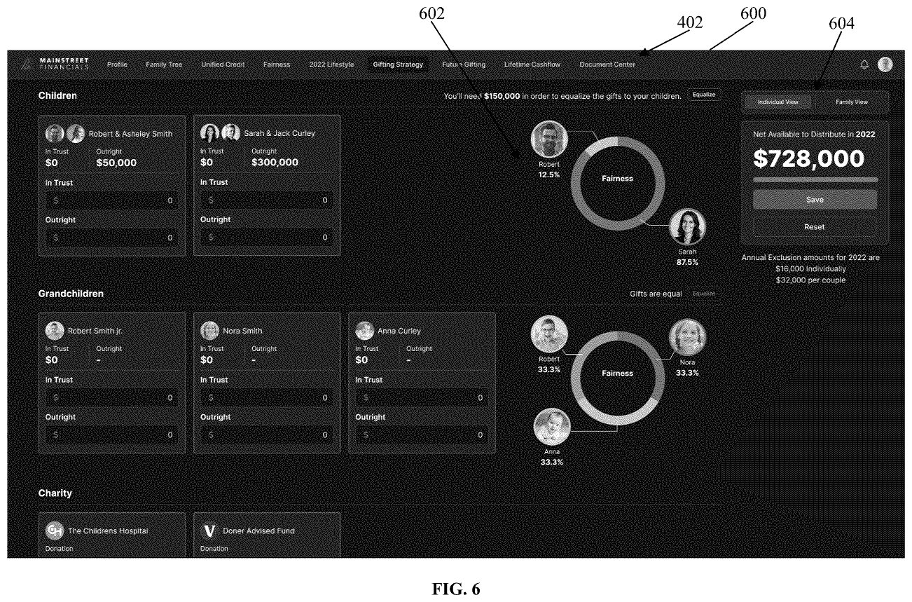

Referring to FIG. 6, an exemplary individual gifting strategy interface 600 is illustrated. The individual gifting strategy interface 600 allows a user to execute gifts directly to their selected recipients to provide equalization and fairness to those individuals. Gifts can be distributed either in trust or outright in this example. The accompanying circle graphs 602 are advantageously configured to automatically adjust based on the executed gifting strategy to graphically depict the impact of the implemented gift and the gifting strategy reflected via the remainder of the gifting strategy interface 600.

In step 504, the financial management system 102 determines whether a current gift was executed by the user via the gifting strategy interface 600. If the financial management system 102 determines a current gift was executed, then the Yes branch is taken to step 506.

In step 506, the financial management system 102 interfaces with third-party server(s) (e.g., the financial institution server 112 and/or investment management server 114) and obtains and stores current gift data within the cumulative gift data 214. The financial management system 102 interfaces with the third-party server(s) to carry out execution of the current gift (e.g., transfer funds according to the input current gift data and/or other stored data (e.g., account number(s), gift amount, gift source, or recipient identity). Thereafter, the executed current gift will be reflected on generated interfaces as described herein that facilitate gifting strategy and fairness, for example, among other types of interfaces. However, if the financial management system 102 determines in step 504 that a current gift has not been executed by the user, then the No branch is taken to step 508.

In step 508, the financial management system 102 determines whether the current view of the gifting strategy interface 600 is modified by the user (e.g., via user interaction with a view button 604 provided via the gifting strategy interface 600). In this example, the view can be family or individual (e.g., as described and illustrated herein with reference to FIG. 6), but other types of views can also be used. If the financial management system 102 determines the view has not been modified, then the No branch is taken back to step 504 and the financial management system 102 effectively waits for a current gift to be executed or the view to be modified. However, if the financial management system 102 determines in step 508 that the view has been modified, then the Yes branch is taken to step 510.

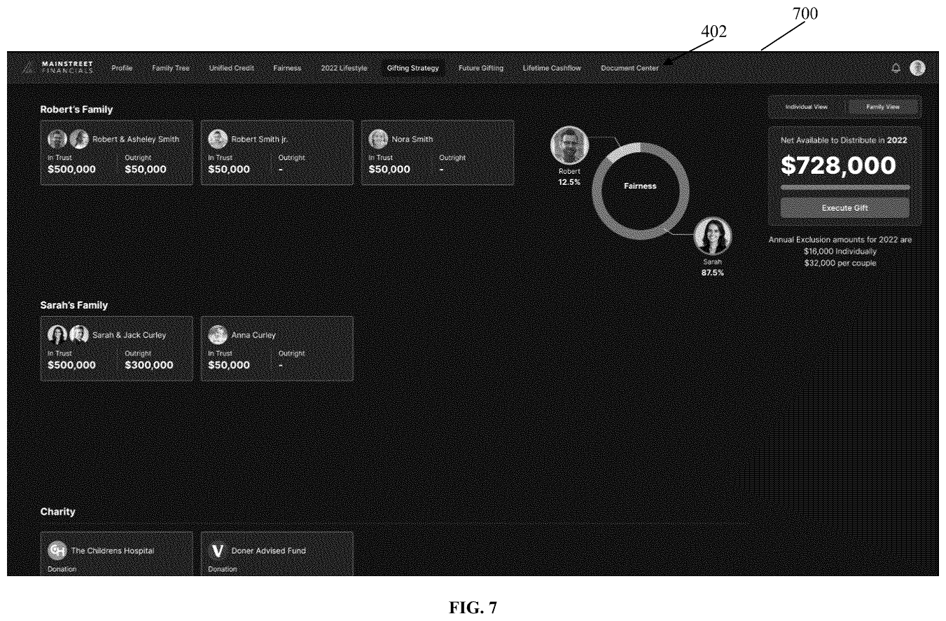

In step 510, the financial management system 102 updates the gifting strategy interface 600 based on the modification. Referring to FIG. 7, an exemplary family gifting strategy interface 700 is illustrated. In this example, the family gifting strategy interface 700 provides a secondary view of additional groupings via family (as compared to individuals) for the gifting strategy options. Accordingly, the various views advantageously allow a user to analyze and set a gifting strategy according to a desired fairness across individuals and family groups. Referring back to step 500 of FIG. 5, if the financial management system 102 determines that the gifting request is not a request for a current gift, then the request is for a future gift and the No branch is taken from step 500 to step 512.

In step 512, the financial management system 102 generates and provides to the user device 110 a future gifting interface based on family demographic data 210 and optionally cumulative gift data 214 associated with the user that reflects historical gifting to family members. The future gifting interface provides future gifting input fields to facilitate automated implementation of a future gift to a family member.

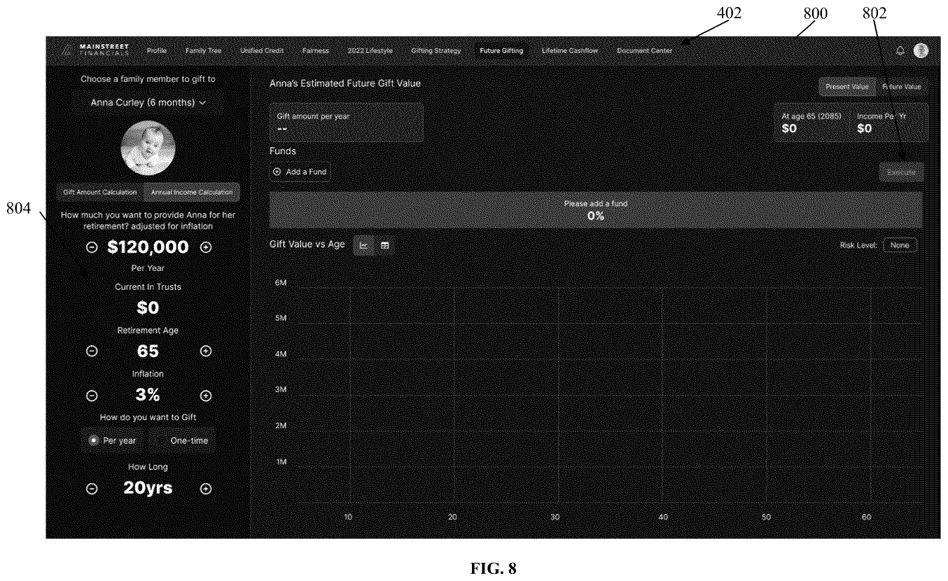

Referring to FIG. 8, an exemplary future gifting interface 800 is illustrated. The future gifting interface 800 in this example allows the user to select a recipient to gift to and determine their gift amount or annual income calculation, the frequency of gifts, and the estimated gift value in both present value and future value. The functionality provided by the future gifting interface 800 helps the user to specify the amount they would like the recipient to receive at an age of their choosing. After selecting investments to be included, the future gifting interface 800 is configured to calculate how much gifting will be needed and for how long to achieve the desired distribution goal. The gifting amount can be calculated on a per year basis or as a one-time gift. The result allows the user to provide a pension for their heir by harnessing the power of long-time growth.

Referring back to FIG. 5, in step 514, the financial management system 102 determines whether a future gift has been executed (e.g., via an execute button 802 of the future gifting interface 800 and the future gifting input fields 804). If the financial management system 102 determines that a future gift has not been executed, then the No branch is taken and the financial management system 102 effectively waits for execution of a future gift. However, if the financial management system 102 determines that a future gift has been executed, then the Yes branch is taken to step 516.

In step 516, the financial management system 102 interfaces with third-party server(s) (e.g., the financial institution server 112 and/or investment management server 114) and obtains and stores future gift data within the cumulative gift data 214. The financial management system 102 interfaces with the third-party server to carry out execution of the future gift (e.g., transfer funds according to the input future gift data and/or other stored data (e.g., account number(s), gift amount, gift source, or recipient identity). Thereafter, the executed future gift will be reflected on generated interfaces as described herein that facilitate gifting strategy and fairness, for example, among other types of interfaces.

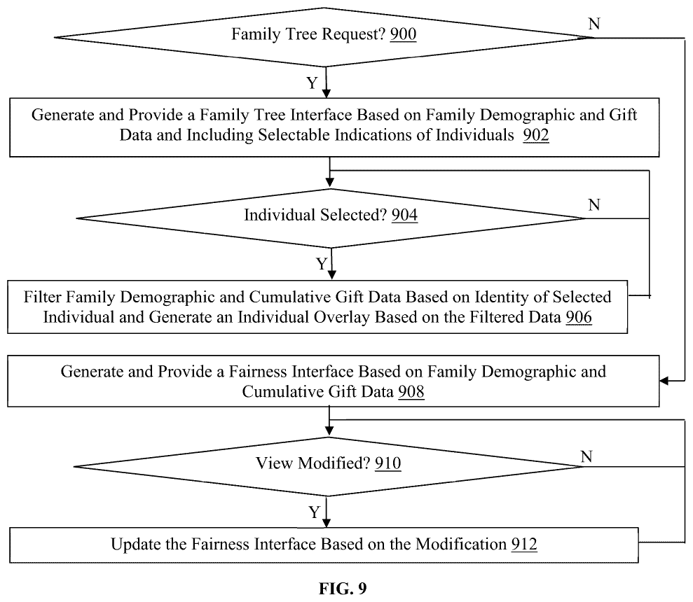

Referring back to FIG. 3, in step 308, the financial management system 102 determines whether a fairness request has been received. The fairness request can be received via a user interaction with the menu bar 402 of the profile dashboard interface 400. In this example, a fairness request can be for a family tree or an individual or family grouping initiated via interaction with a family tree link or a fairness link of the menu bar 402 of the profile dashboard interface 400, respectively, although other types of fairness requests could also be received in other examples. If the financial management system 102 determines that a fairness request has been received, then the Yes branch is taken to step 900 of FIG. 9.

Referring to FIG. 9, a flowchart of an exemplary method for managing fairness requests is illustrated. In step 900, the financial management system 102 determines whether the fairness request is a family tree request (e.g., based on the link selected from the menu bar 402 of the profile dashboard interface 400). If the financial management system 102 determines that the fairness request is a family tree request, then the Yes branch is taken to step 902.

In step 902, the financial management system 102 generates and provides to the user device 110 a family tree interface based on family demographic data 210 and cumulative gift data 214 and including selected indications of individuals. The family tree includes a graphical depiction of the family tree associated with the user and portions of the stored gift and other data associated with individuals identified in the family tree (e.g., respective cumulative historical gift amount). Selection of individuals facilitates a more granular analysis of the associated gifting strategy.

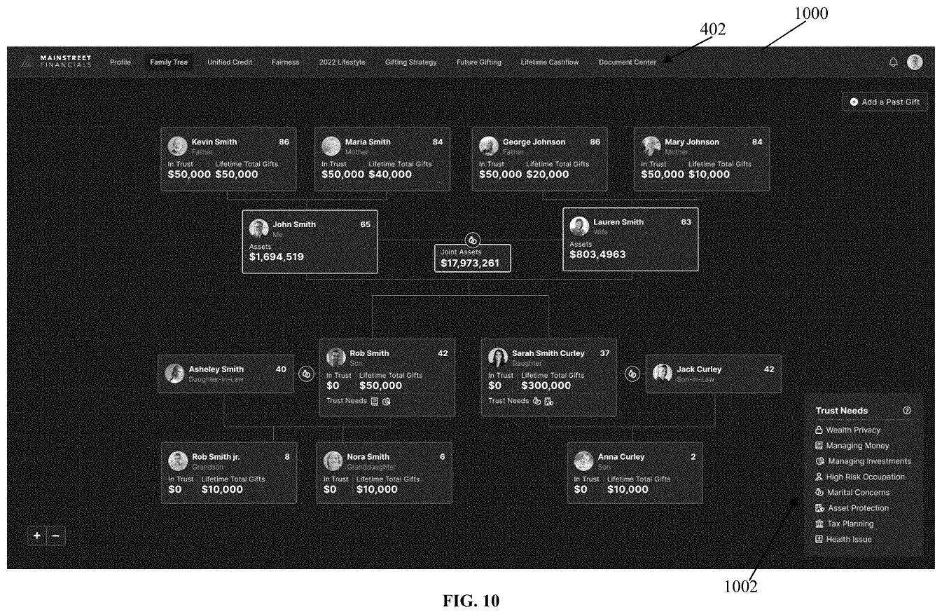

Referring to FIG. 10, an exemplary family tree interface 1000 is illustrated. The family tree interface 1000 in this example includes a diagram that displays all members of the user's household and extended relationships in individual boxes, which also contain relevant financial and gifting information. The family tree interface 1000 includes a trust needs legend 1002, which provides additional insight into the gifting needs of each individual (e.g., an individual has a high-risk occupation or marital concerns).

Referring back to FIG. 9, in step 904, the financial management system 102 determines whether an individual is selected from the family tree interface 1000. If the financial management system 102 determines that an individual has been selected, then the Yes branch is taken to step 906.

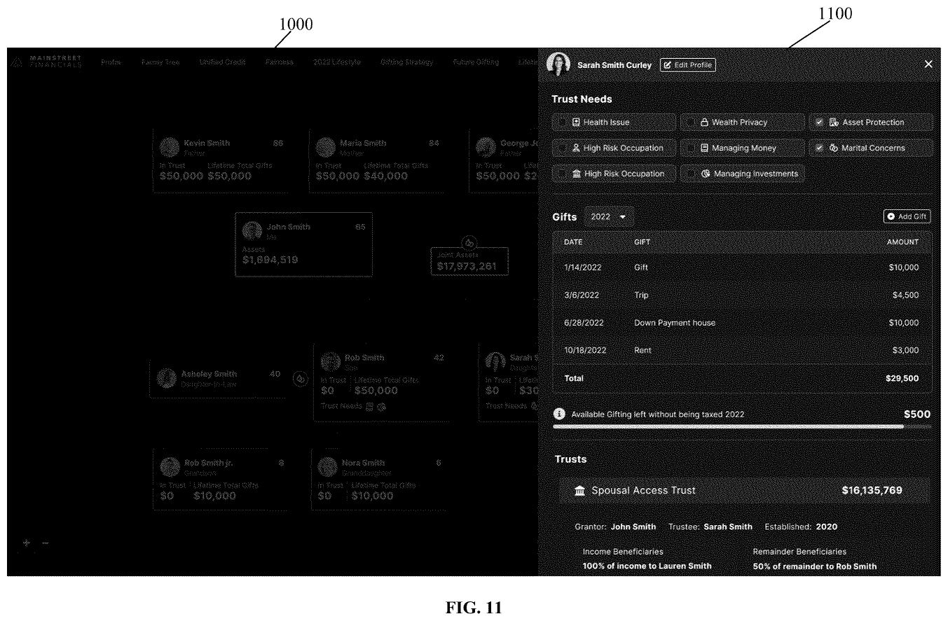

In step 906, the financial management system 102 filters stored family demographic data 210 and cumulative gift data 214 for the user based on the identity of the selected individual and generates an individual overlay based on the filtered data, although the filtered data can be presented in other ways in other examples. Referring to FIG. 11, the family tree interface 1000 of FIG. 10 with an individual overlay 1100 is illustrated. Via the individual overlay 1100, the user or advisor has the opportunity to review specific information and make necessary changes. The relevant information for each individual includes their trust needs and any trusts or gifts they have received or continue to benefit from. Additionally, the individual overlay 1100 in this example includes an option to review all past gifts and the individual overlay 1100 provides the user the opportunity to review each person and situation, which does not currently exist in the art in granular detail in an interactive environment.

Referring back to FIG. 9, if the financial management system 102 determines in step 900 that the fairness request was not a family tree request but was instead another type of fairness request, then the No branch is taken to step 908. In step 908, the financial management system 102 generates and provides a fairness interface based on family demographic data 210 and cumulative gift data 214 for the user.

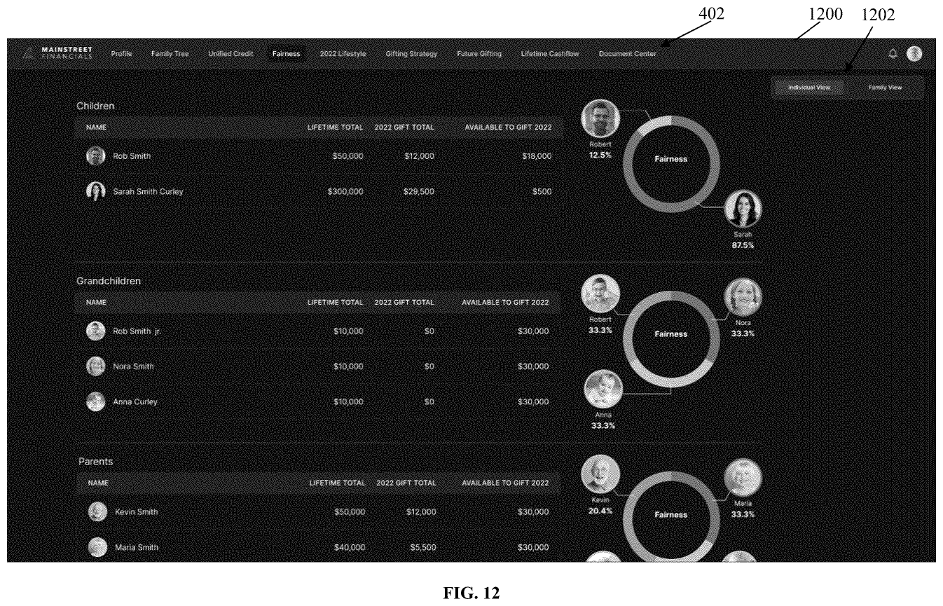

Referring to FIG. 12, an exemplary individual fairness interface 1200 is illustrated. The individual fairness interface 1200 in this example displays all the user's recipients including children, grandchildren, parents, and others. Each recipient is presented with their lifetime total gift amount, current year total gift amount, and available to gift total amount for the current year (e.g., according to tax laws and/or available assets). The accompanying diagrams in the individual fairness interface 1200 graphically illustrate the allocation of the gifting to all family members. Thus, the individual fairness interface 1200 allows the user to review a visual representation of their gifting strategy.

Referring back to FIG. 9, in step 910, the financial management system 102 determines whether the current view of the individual fairness interface 1200 is modified by the user (e.g., via user interaction with a view button 1202 provided via the individual fairness interface 1200). In this example, the view can be family or individual (e.g., as described and illustrated with reference to FIG. 12), but other types of views can also be used. If the financial management system 102 determines the view has not been modified, then the No branch is taken back to step 910 and the financial management system 102 effectively waits for the view to be modified. However, if the financial management system 102 determines in step 910 that the view has been modified, then the Yes branch is taken to step 912.

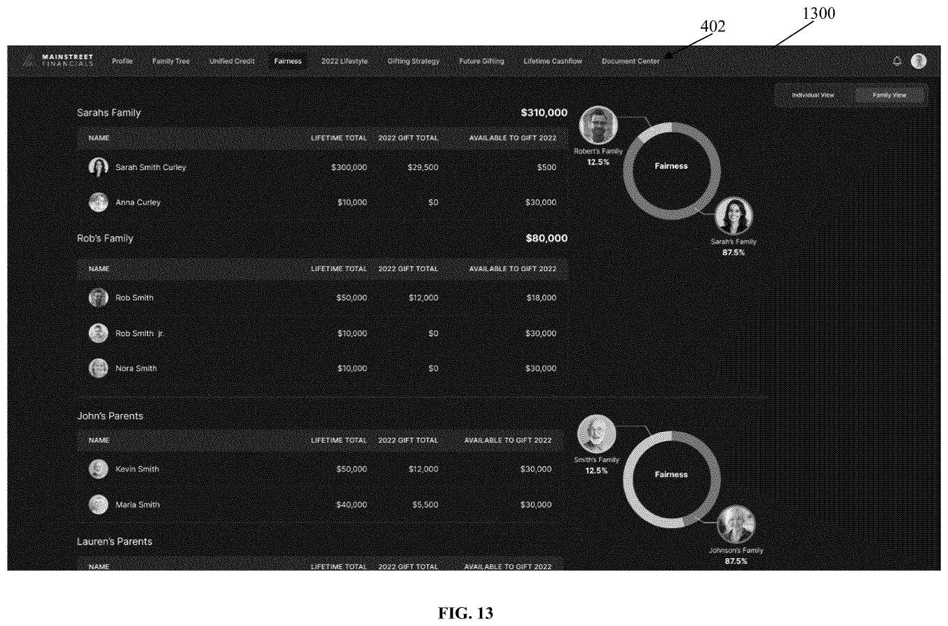

In step 912, the financial management system 102 updates the individual fairness interface 1200 based on the modification. Referring to FIG. 13, an exemplary family fairness interface 1300 is illustrated. In this example, the family fairness interface 1300 provides an additional view for all recipients grouped by family units, which is an additional visual aid for the user or advisor to utilize in generating and analyzing a gifting strategy. Accordingly, the various views again advantageously allow a user to analyze and set a gifting strategy according to a desired fairness across individuals and family groups. Referring back to FIG. 9, subsequent to updating the individual fairness interface in step 912, the financial management system 102 proceeds back to step 910 in this example.

Referring back to FIG. 3, if in step 308 the financial management system 102 determines that a fairness request has not been received, then the No branch is taken to step 310. In step 310, the financial management system 102 determines whether a unified credit request has been received (e.g., via the menu bar 402 of the profile dashboard interface 400). If the financial management system 102 determines a unified credit request has been received, then the Yes branch is taken to step 312.

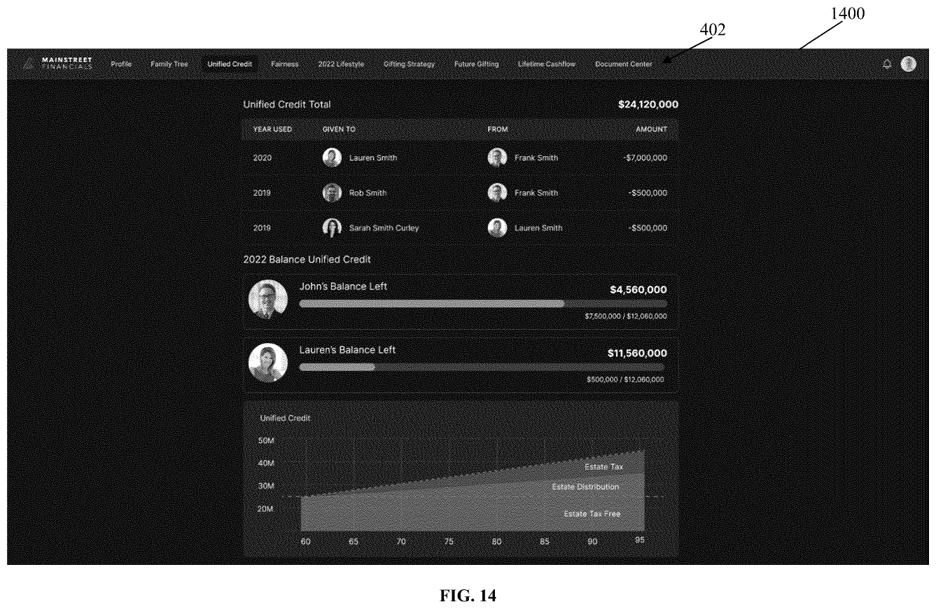

In step 312, the financial management system 102 generates and provides to the user device 110 a unified credit interface based on stored personal financial data 212 and historical gift data within the cumulative gift data 214. The unified credit interface illustrates historical unified credit usage to facilitate analysis of such usage and remaining available unified credit based on such usage. Referring to FIG. 14, an exemplary unified credit interface 1400 is illustrated. The unified credit interface 1400 in this example displays the recipients of unified credit for the current year and all previous years, and therefore provides a planning feature that allows the user to track and monitor their unified credit usage.

Referring back to FIG. 3, if in step 310 the financial management system 102 determines that a unified credit request has not been received, then the No branch is taken to step 314. In step 314, the financial management system 102 determines whether a lifestyle request has been received (e.g., via the menu bar 402 of the profile dashboard interface 400). If the financial management system 102 determines a lifestyle request has been received, then the Yes branch is taken to step 316.

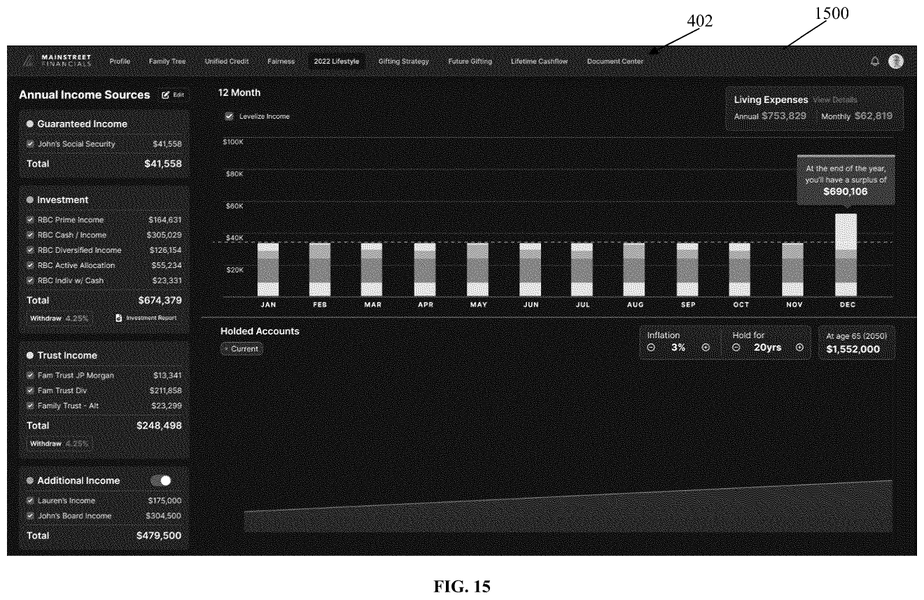

In step 316, the financial management system 102 generates and provides to the user device 110 a lifestyle interface based on stored personal financial data 212. The lifestyle interface graphically illustrates monthly expenses for the user in some examples, although other types of lifestyle-related information (e.g., annual expenses, expense type/category, or entity associated with the expense) can also be used in other examples. Referring to FIG. 15, an exemplary lifestyle interface 1500 is illustrated. In this example, the lifestyle interface 1500 illustrates the monthly expenses of the user and allows for greater exploration of the funds listed under annual income sources to inform gifting strategies.

Referring back to FIG. 3, if in step 314 the financial management system 102 determines that a lifestyle request has not been received, then the No branch is taken to step 318. In step 318, the financial management system 102 determines whether a lifetime request has been received (e.g., via the menu bar 402 of the profile dashboard interface 400). If the financial management system 102 determines in step 318 that a lifetime request has been received, then the Yes branch is taken to step 320.

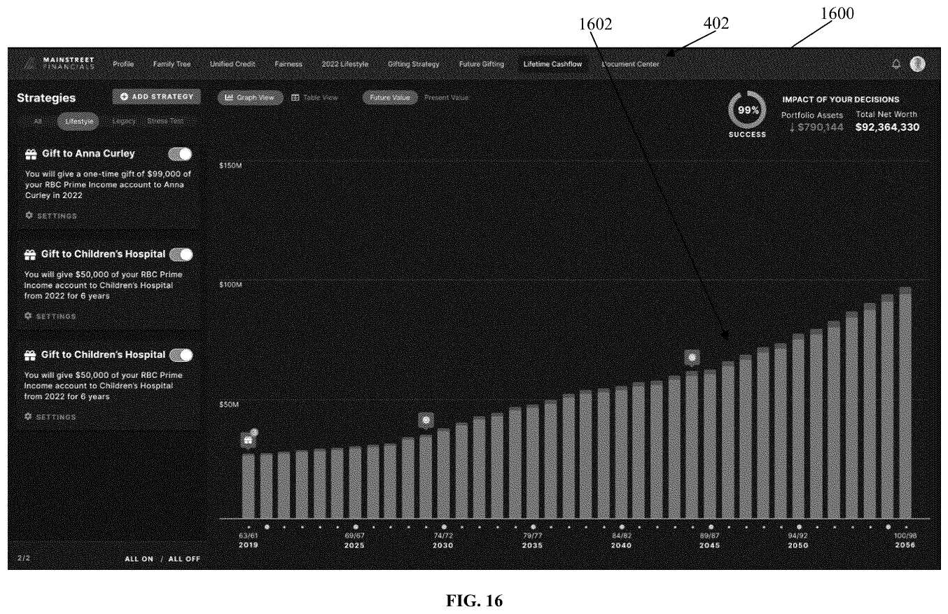

In step 320, the financial management system 102 generates and provides to the user device 110 a lifetime cash flow interface based on stored personal financial data 212 and historical gift data within the cumulative gift data 214. The lifetime cash flow interface includes a graph illustrating an impact of a gifting strategy currently employed by the user, for example, although other information can also be included in the lifetime cash flow interface in other examples. Referring to FIG. 16, an exemplary lifetime cash flow interface 1600 is illustrated. The lifetime cash flow interface in this example displays the impact of a user's gifting strategy decisions in a visual format in the form of a bar graph 1602 in this example.

Subsequent to generating and providing the lifetime cash flow interface 1600 in step 320, or if the financial management system 102 determines in step 318 that a lifetime request has not been received and the No branch is taken, then the financial management system 102 proceeds back to step 306 and effectively waits for another request to be received (e.g., via a user interaction with the profile dashboard interface 400). In other examples, one or more of steps 306-320 can be performed in parallel for any number of users and/or in a different order. Additionally, while in the examples explained herein the financial management system 102 receives requests from the user device 110 subsequent to the user login request, in other examples, the financial management system 102 can provide a web application or interactive GUI that is configured to process the requests and generate an output to display new or modified versions of the various interfaces described and illustrated herein.

Accordingly, this technology more effectively and efficiently facilitates monetary gifting strategies by financial and wealth advisors and/or high-net-worth individuals by providing a plurality of different types of interfaces with graphical elements and functionality that allow for granular and visual analysis of the impact of gifting strategies. For example, the impact of gifting strategies with respect to individual and family fairness and the user's lifestyle and unified credit usage can be more effectively analyzed with this technology. Additionally, this technology facilitates of current and future gifts thereby providing an integrated platform for gifting strategy analysis and implementation.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method implemented by a financial management system and comprising:
obtaining and storing demographic data and cumulative gift data for an individual, wherein the demographic data comprises identities of family members of, and a relationship of the family members to, the individual and the gift data comprises an amount and a first one of the identities for gifts made by the individual;
providing to a user device for display a current gifting strategy interface following authentication of login credentials corresponding to the individual, wherein the current gifting strategy interface is generated based on at least the demographic data and the cumulative gift data and comprises a first graphical illustration of a respective monetary value of a subset of the gifts made by the individual to a subset of the family members;
executing a current gift in response to a current gift request received from the user device via the current gifting strategy interface, wherein the current gift request comprises current gift data obtained via current gifting input fields of the current gifting strategy interface and comprising at least a current gift amount and a second one of the identities, wherein the second one of the identities is associated with one of the subset of the family members; and
automatically adjusting the first graphical illustration to reflect, and
updating the cumulative gift data based on, the executed current gift.

2. The method of claim 1, further comprising obtaining and storing financial data for the individual, wherein the financial data comprises indications of assets of the individual and the current gift data comprises one of the indications corresponding to a source of the current gift.

3. The method of claim 1, further comprising communicating the current gift data via one or more communication networks and a provided application programming interface (API) to a financial institution server or an investment management server to execute the current gift and facilitate a current or future transfer of electronic funds.

4. The method of claim 2, further comprising providing to the user device for display a unified credit interface generated based on the financial data and the cumulative gift data and comprising a second graphical illustration of historical unified credit utilization of the individual.

5. The method of claim 1, wherein a subset of the family members comprises a plurality of individuals within the family members or one or more subfamilies of a family that comprises the family members.

6. The method of claim 2, wherein the cumulative gift data comprises historical gift data and future gift data.

7. The method of claim 6, further comprising providing to the user device for display a lifetime interface comprising a second graphical illustration of a wealth of the individual over a period time, wherein the wealth is determined based on the financial data and the cumulative gift data and the second graphical illustration reflects an impact of a gifting strategy reflected in the cumulative gift data.

8. The method of claim 1, further comprising:
generating a family tree graphically illustrating the relationship of the family members to the individual determined from the demographic data; and
providing to the user device for display a family tree interface comprising the generated family tree and an indication of a cumulative monetary value of one or more of the gifts to each of the family members determined from the cumulative gift data.

9. The method of claim 8, wherein the family tree interface is further configured to generate an overlay in response to a selection from the user device of one of the family members, wherein the overlay comprises selectable trust needs associated with the one of the family members and a breakdown of the cumulative monetary value of the one or more of the gifts to the one of the family members.

10. A financial management system, comprising memory comprising instructions stored thereon and one or more processors coupled to the memory and configured to execute the stored instructions to:
provide to a user device for display a current gifting strategy interface following authentication of login credentials corresponding to an individual, wherein the current gifting strategy interface is generated based on at least demographic data and cumulative gift data for the individual and comprises a first graphical illustration of a monetary value of each of a subset of gifts made by the individual to a subset of family members of the individual;
execute a current gift in response to a current gift request received from the user device via the current gifting strategy interface, wherein the current gift request comprises current gift data obtained via current gifting input fields of the current gifting strategy interface and comprising at least a current gift amount and a first one of a plurality of identities of the family members, wherein the first one of the identities is associated with one of the subset of the family members; and
automatically adjust the first graphical illustration to reflect, and update the cumulative gift data based on, the executed current gift.

11. The financial management system of claim 10, wherein the one or more processors are further configured to execute the stored instructions to provide to the user device for display a future gifting interface comprising a second graphical illustration and a plurality of future gifting input fields comprising one or more of a future gift amount, a retirement age, an inflation rate, a gift frequency, or a gift duration.

12. The financial management system of claim 11, wherein the future gifting interface is configured to automatically adjust the second graphical illustration in response to a received modification of a value associated with one or more of the future gifting input fields.

13. The financial management system of claim 12, wherein the second graphical illustration reflects an estimate future gift value of the future gift.

14. The financial management system of claim 11, wherein the one or more processors are further configured to execute the stored instructions to:
execute a future gift in response to a future gift request received from the user device via the future gifting strategy interface, wherein the future gift request comprises a third one of the identities and future gift data obtained via the future gifting input fields; and
update the cumulative gift data based on the executed future gift.

15. The financial management system of claim 10, wherein the one or more processors are further configured to execute the stored instructions to obtain and store the demographic data and the cumulative gift data for the individual, wherein the demographic data comprises the identities and a relationship of the family members to the individual and the gift data comprises an amount and a second one of the identities for gifts made by the individual.

16. A non-transitory computer readable medium having stored thereon instructions comprising executable code that, when executed by one or more processors, causes the one or more processors to:
provide to a user device for display a current gifting strategy interface following authentication of login credentials corresponding to an individual, wherein the current gifting strategy interface is generated based on at least demographic data and cumulative gift data for the individual and comprises a first graphical illustration of a monetary value of each of a subset of gifts made by the individual to a subset of family members of the individual;
communicate current gift data via communication networks and a provided application programming interface (API) to a financial institution server or an investment management server to execute a current gift and facilitate a transfer of electronic funds in response to a current gift request received from the user device via the current gifting strategy interface, wherein the current gift request comprises current gift data obtained via current gifting input fields of the current gifting strategy interface and comprising at least a current gift amount and a first one of a plurality of identities of the family members and the first one of the identities is associated with one of the subset of the family members; and
automatically adjust the first graphical illustration to reflect, and update the cumulative gift data based on, the executed current gift.

17. The non-transitory computer readable medium of claim 16, wherein the executable code, when executed by the one or more processors, further causes the one or more processors to obtain and store financial data for the individual, wherein the financial data comprises indications of assets of the individual and the current gift data comprises one of the indications corresponding to a source of the current gift.

18. The non-transitory computer readable medium of claim 16, wherein the executable code, when executed by the one or more processors, further causes the one or more processor to:
generate a family tree graphically illustrating a relationship of the family members to the individual determined from the demographic data; and
provide to the user device for display a family tree interface comprising the generated family tree and an indication of a cumulative monetary value of one or more of the gifts to each of the family members determined from the cumulative gift data.

19. The non-transitory computer readable medium of claim 17, wherein the cumulative gift data comprises historical gift data and future gift data and the executable code, when executed by the one or more processors, further causes the one or more processor to provide to the user device for display a lifetime interface comprising a second graphical illustration of a wealth of the individual over a period time, wherein the wealth is determined based on the financial data and the cumulative gift data and the second graphical illustration reflects an impact of a gifting strategy reflected in the cumulative gift data.

20. The non-transitory computer readable medium of claim 16, wherein the executable code, when executed by the one or more processors, further causes the one or more processor to:
provide to the user device for display a future gifting interface comprising a second graphical illustration and a plurality of future gifting input fields;
execute a future gift in response to a future gift request received from the user device via the future gifting strategy interface, wherein the future gift request comprises a third one of the identities and future gift data obtained via the future gifting input fields; and
update the cumulative gift data based on the executed future gift.
